(19) United States
(12) Patent Application Publication
(10) Pub. No.: US 2021/0142951 A1
(43) Pub. Date: May 13, 2021

(54) ELECTROSTATIC ENERGY GENERATOR USING A PARALLEL PLATE CAPACITOR

(71) Applicant: Ariel Scientific Innovations Ltd., Ariel (IL)

(72) Inventors: Asher YAHALOM, Givat Shmuel (IL); Moshe AVERBUKH, Beer Sheva (IL); Shailendra RAJPUT, Ariel (IL)

(73) Assignee: Ariel Scientific Innovations Ltd., Ariel (IL)

(21) Appl. No.: 17/095,894

(22) Filed: Nov. 12, 2020

(30) Foreign Application Priority Data
Nov. 12, 2019 (IN) 201921045972

(51) Int. Cl. H01G 5/16; H01G 5/013; H01G 5/011; H01G 5/40

(52) U.S. Cl. CPC H01G 5/16; H01G 5/40; H01G 5/011; H01G 5/0132

(57) ABSTRACT

A generator comprises a parallel plate capacitor which in turn is made up of a mobile plate and a stationary plate, the plates facing each other in parallel at their internal faces. The mobile plate moves up and down due to an external mechanical force to increase and decrease the gap between the plates, leading to a change in the capacitance between the mobile plate and the stationary plate. The internal faces of the plates have dielectric surfaces, for example formed by oxidizing. The generator is useful for example for small-scale mobile devices such as wearables, and to any device where motion is available to transform into electricity.

### RELATED APPLICATION

This application claims the benefit of priority of Indian Patent Application No. 201921045972 filed on Nov. 12, 2019, the contents of which are incorporated by reference as if fully set forth herein in their entirety.

### FIELD AND BACKGROUND OF THE INVENTION

The present invention, in some embodiments thereof, relates to an electrostatic generator using a parallel-plate capacitor and, more particularly, but not exclusively, to a way of providing a reliable source of energy for small electrical devices.

A reliable and sustainable electrical power supply is a crucial factor for portable electronic devices including smartphones, off-grid measurement taking, appliances that need to transmit, particularly from remote locations and others. Power feed affects the performance and cost of these devices. Therefore, portable energy generators are high in demand and these circumstances support research in the areas of energy generation methods. The idea of harvesting electricity from mechanical energy motivates searches for new technologies. Various kinds of electromagnetic generators have been proposed and applied but do not provide required performance levels for portable applications. To fulfill the need, capacitor-based electrostatic generators can be a suitable candidate as capacitors may provide higher power density and longer cycle lifetime than that of analogous electromagnetic devices, but again, suitable performance levels at the small scale needed for portable devices has not been achieved.

Energy harvesting or the process of acquiring energy from the surrounding environment has been a continuous human endeavor throughout history. There are two popular mechanisms that can be used to convert motion into electrical energy: electromagnetic and electrostatic. On the micro-scale, electrostatic generators are more suitable than electromagnetic generators. Electrostatic generators include the Van de Graaff generator from the early twentieth century, which is probably the most famous. Recently, mechanically originated variable capacitance has been used for energy generation, thus Mitcheson P. D., et al., Electrostatic Microgenerators. Measurement and Control, 2008. 41(4): p. 114-119 have shown energy generation using variable capacitance for two types of configurations. They propose that capacitance can be varied by changing the gap between both electrodes. It is well known that the capacitance is a function of the geometry of electrodes and permittivity of materials surrounding them. Tashiro et al. Development of an electrostatic generator for a cardiac pacemaker that harnesses the ventricular wall motion. Journal of Artificial Organs, 2002. 5(4): p. 0239-0245 also designed an electrostatic generator with the aim of driving a cardiac pacemaker permanently without a battery. One serious issue with electrostatic generators is that voltages can climb to the point where an electric arc discharges between electrodes. U.S. Pat. No. 6,936,994, describes a device which relies on a small reverse current through diodes for trickle charging capacitor plates of miniature variable capacitors to a voltage level near the energy source voltage. Beside these developments, other issues with electrostatic generators remain unsolved:
Relatively small specific power
Significant dielectric layer between capacitor's plates
High voltage output

Efficient power generation requires solution of these issues in order to allow a power generator based on such a principle to be used as a sustainable energy source for low-power devices.

Additional teachings regarding generating power using capacitor plates include the following:

1. US2014346782(A1)—MICRO POWER GENERATOR AND POWER GENERATION METHOD USING LIQUID DROPLET—discloses an AC voltage generated by vibration of capacitor plates.
2. DE102011080149(A1)—discloses a capacitor e.g. plate-type capacitor, for use in e.g. generator utilized for conversion of mechanical energy into electrical energy. This citation has a dielectric layer, where gas-filled volumes are arranged in pores in a dielectric layer
3. US2015295516(A1)—discloses an energy conversion device using a change in contact surface with a liquid.
4. Micro-Machined Variable Capacitors for Power Generation P. Miao, A. S. Holmes, E. M. Yeatman and T. C. Green—discloses how micro-power generators turn inertia into electrical energy using capacitors.
5. JP2010068643(A) discloses electrostatic induction type power generation device and method for manufacturing the same
6. U.S. Pat. No. 2,567,373(A) discloses an electrostatic generator
7. US2010194236(A1) discloses a capacitive Electric Current Generator

### SUMMARY OF THE INVENTION

The present embodiments seek to overcome various of the problems of the prior art in order to improve the performance of electrostatic generation on parallel plates, and thus to provide devices which are practical for small portable devices as well as for any other kind of load.

In the present embodiments, the plates of the capacitor may be of any conductive material for example graphite or metal, have a thin dielectric layer, for example a thin oxidized porous layer may be used to provide an external surface which may then be immersed in electrolyte. The surface roughness increases the area of the plate.

Surface roughness and porous structure extend to both conductive plate regions and the dielectric (airgap) region.

A membrane may be inserted between the oxide layers on the respective plates.

A method of constructing the generator comprises providing two plates, and providing a think dielectric layer, for example by growing a thin oxide layer on one surface of each plate, then inserting an electrolyte-soaked membrane between the electrodes.

According to an aspect of some embodiments of the present invention there is provided a generator comprising a parallel plate capacitor, the parallel plate capacitor comprising a mobile plate and a stationary plate, the mobile and stationary plates each having external and internal faces, the mobile and stationary plates facing each other in parallel at the internal faces, the mobile plate being movable by an external mechanical force to increase and decrease a gap with the stationary plate, thereby to change the capacitance between the mobile plate and the stationary plate, the internal faces comprising oxidized surfaces respectively.

In an embodiment, the dielectric, for example oxidized, surfaces are porous.

In an embodiment, the dielectric, for example oxidized, surface of the stationary plate is immersed in an electrolyte solution.

In embodiments a porous membrane is placed between the internal faces.

In an embodiment, the porous membrane is soaked in the electrolyte.

In an embodiment, the electrolyte is a salt solution.

In an embodiment, the plates are aluminum and the oxidized surfaces comprise aluminum oxide.

Alternatively, the plates are tantalum and the oxidized surfaces comprise tantalum oxide.

Apart from aluminium and tantalum, other metals may be used.

In an embodiment, the mobile plate is connected to a flexible surface to move in response to the external mechanical force.

In an embodiment, the mobile plate is further connected to a spring to provide a restoring force against the external mechanical force.

An embodiment is configured to cause the mobile plate to reciprocate in response to the external mechanical force.

In an embodiment, the mobile plate is configured as a piston.

In an embodiment, the mobile plate is configured to move between a low capacitance position in which there is no airgap between the plates, and a high capacitance position in which there is an airgap between the plates.

In an embodiment, the parallel plate capacitor is connected via a diode to a voltage source to allow for charging when in the low capacitance position but to prevent discharge to the voltage source from the high capacitance position.

In an embodiment, the parallel plate capacitor is connected via a diode to a load to allow for discharging to the load when in the high capacitance position but to prevent discharge to the load until the high capacitance position is reached.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic diagram showing the advantage of a non-smooth plate surface according to embodiments of the present invention;

FIG. 2 is a simplified schematic diagram showing the filling of the gap between the plates with an electrolyte and a porous membrane;

FIG. 3 is a simplified schematic diagram illustrating a generator according to an embodiment of the present invention;

FIG. 4 is a graph indicating amounts of energy available for different capacitances using the present embodiments;

FIG. 5 is a simplified schematic diagram illustrating a generator according to embodiments of the present invention in which a spring provides a restoring force against an external movement;

FIG. 6 is a simplified schematic diagram illustrating a generator according to embodiments of the present invention in which an alternating or reciprocating force is provided to the mobile electrode according to embodiments of the present invention;

FIG. 7 is a simplified schematic diagram illustrating a generator according to embodiments of the present invention in which the upper electrode is a piston; and

FIG. 8 is a theoretical diagram of an electric circuit incorporating a generator according to embodiments of the present invention.

### DESCRIPTION OF SPECIFIC EMBODIMENTS OF THE INVENTION

The present invention, in some embodiments thereof, relates to an electrostatic generator using a parallel-plate capacitor and, more particularly, but not exclusively, to a reliable source of energy for small electrical devices.

The present disclosure relates to the generation of electrical energy from a parallel plate capacitor which capacitance is changed by the axial movement of one plate against another. The plates may be conductive, for example graphite or metal or the like. It is shown that the efficiency of a generator can be enhanced significantly using an oxidized external surface in which porous plates having such an oxidized external surface are immersed in an electrolyte solution.

The present embodiments may also relate to generating a large voltage which can be useful as a high voltage source. The present embodiments may increase the efficiency of a power generator.

The electrolyte-soaked membrane plays two roles: one is to rule out any effect of the air gap and another is to prevent direct mechanical contact between neighboring layers. The second role may significantly increase the service life of an appliance according to the present embodiments.

Another advantage of the present embodiments relates to use as a voltage source for radiation devices such as a gyrotron. As capacitance changes significantly, the voltage across the capacitor increases sharply (V≈1/C).

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Referring now to the drawings, FIG. 1 illustrates a generalized embodiment of the present invention showing how, in capacitor 10, an actual distance between an upper plate 12 and lower plate 14 may be changed into an effectively larger distance by virtue of the rough surfaces on both plates, here schematically represented by a zig-zag surface but in fact provided by oxidizing a surface to provide a porous oxide layer. The oxidized surfaces may also increase the surface area of each plate. Distance 16 indicates the apparent distance between the two plates, but larger distance 18 is the effective distance that governs the voltage.

### Principle of Energy Generation

Considering FIG. 1, the present embodiments may disclose a method for energy generation using variable capacitance of a parallel plate capacitor. Capacitance (C) of a parallel plate capacitor is expressed as:

$${C}_{1} = \frac{{ɛ}_{r} {ɛ}_{0} A}{{d}_{1}}$$

where ε₀ is permittivity of the vacuum, εᵣ is the relative permittivity of the dielectric material, A is the area of capacitor plate and d₁ is the distance between the two capacitor plates, that is the combined thickness of the dielectric layer and the air gap.

Let us assume that the capacitor is charged up to a specific voltage (V₁) from the voltage (current) source and later disconnected from the source in order to maintain constant charge across capacitor plates (Q=CV). In this condition, the initial electrostatic energy (E₁) of capacitor is expressed as:

$${E}_{1} = \frac{1}{2} {C}_{1} {V}_{1}^{2} = \frac{{Q}^{2}}{2 {C}_{1}}$$

If the distance between the electrodes increases with the application of mechanical force then both relative permittivity and capacitance decrease significantly (C₂<<C₁). As a result, the stored electrostatic energy of the capacitor increases substantially. If the distance between the electrodes is d₂ then the capacitance (C₂) and the electrostatic energy (E₂) are expressed as:

$${C}_{2} = \frac{{ɛ}_{r} {ɛ}_{0} A}{{d}_{2}}$$

$${E}_{2} = \frac{{Q}^{2}}{2 {C}_{2}} = \frac{{Q}^{2}}{2 {C}_{1}} ( \frac{{C}_{1}}{{C}_{2}} ) = \frac{{ɛ}_{{r}_{1}}}{{ɛ}_{{r}_{2}}} \cdot \frac{{d}_{2}}{{d}_{1}} \cdot {E}_{1}$$

where εᵣ_{₂} and εᵣ_{₂} are effective relative permittivity values for distances d₁ and d₂ respectively. In this process, applied mechanical energy is converted to electrical energy by the means of the variable-capacitance. If the capacitor is connected to some load (e.g. any power deficient device) then capacitor energy is transferred to the load and the capacitor is discharged. After that, the distance between the electrodes is restored to its initial value and the capacitor is again connected to the source for charging. Such repetitive actions of capacitor charging-discharging during axial movement of plates provide a flow of electrical energy to the load, and in practice transform mechanical energy to electrical energy.

The main problem of the prior art electrostatic generator is the low generating power which is caused by a small initial capacitance. The capacitance is determined by the thickness of the dielectric layer as well as the size of the air gap between the dielectric and conductive plates. The surface roughness and porous structure of both dielectric and conductive layers makes a strong contribution to the air gap as illustrated by the difference between distances 16 and 18 in FIG. 1. The air gap is the main cause for small initial capacitance because of the very low permittivity of air.

Referring now to FIG. 2, and the negative effect of the air gap can be eliminated by the placement of an electrolyte-soaked porous membrane 20. The electrolyte may fill pores on the surface of plates and may thus significantly decrease the air gap between the electrodes. As a result, the capacitance may be substantially enhanced. In addition, the presence of a membrane may prevent direct mechanical contact between the two oxide layers. The use of such a membrane may significantly increase the service life of a device made according to the present embodiments. Thus, the above-mentioned membrane has two important functions one of which is neglecting air gap presence and another one is a preventing direct contact between electrodes.

In order to achieve such a capacitor in practice, firstly, a thin oxide layer is grown on one surface of each of the electrodes (e.g. porous Al₂O₃ layer on Al). Secondly, an electrolyte-soaked membrane is inserted between the two electrodes.

The present embodiments may thus provide a method for energy generation using the variable capacitance of a parallel plate capacitor.

It was noted in experiments that the insertion of an electrolyte-soaked membrane significantly enhanced the capacitance. We observed that the capacitance significantly enhances from ˜4 nF to ˜5 μF on the insertion of an electrolyte-soaked membrane between electrodes. In other words, an electrolyte-soaked membrane helps to increase capacitance almost 1000 times, which is a significant change for energy generation. The membrane was soaked in a 0.7M Na₂SO₄ salt water solution. Both the electrodes made of aluminum (Al) have dimensions of 0.3 cm×0.3 cm×0.08 cm. A thin oxide layer was grown using a standard anodization process in sulfuric acid.

Reference is now made to FIG. 3, which is a schematic diagram showing an embodiment according to the present invention of an electrostatic generator. The basic design comprises two electro-conductive electrodes 30 and 32, which operate as capacitor plates. The inner, facing, surfaces 34 and 36, of the two electrodes are covered with a thin dielectric layer, which may be grown using a standard anodization process. One of the electrodes 32 is immersed in electrolyte solution 33 inside a container 38 to form a box assembly 39. A porous membrane 40 is placed on the top of the immersed electrode in order to protect against leakage of electrolyte, and the membrane may also provide electrical contact between the two electrode surfaces. The upper electrode 30 is placed over the box assembly 39 and the distance—airgap 42—between the two electrodes is changed by means of mechanical forces. Such an arrangement may ensure a minimal air gap between the electrodes is maintained and may also reduce the effect of surface roughness.

That is to say, the figure shows a generator comprising a parallel plate capacitor. The parallel plate capacitor comprises a mobile plate 30 and a stationary plate 32. The mobile and stationary plates each have external and internal faces, and face each other in parallel at the internal faces. The mobile plate is movable by an external mechanical force to increase and decrease the gap with the stationary plate, and may thus increase and decrease the capacitance between the mobile plate and the stationary plate which is to say the capacitance of the parallel plate capacitor. The internal faces have surfaces which are oxidized so that the oxidized or rough surfaces face each other.

The present embodiments may use a wide range of electrode materials. The plates may be aluminum so that the oxidized surfaces comprise aluminum oxide. Alternatively, the plates may be tantalum and the oxidized surfaces may thus comprise tantalum oxide. More particularly, oxides of the aluminum (Al) and tantalum (Ta) metals (Al₂O₃ and Ta₂O₅) show good dielectric properties, specifically the relative permittivity and breakdown voltage. Relative permittivity (Cᵣ) and breakdown voltage (V_{b}) of Ta₂O₅ are 22-30 and 3-4 MV/cm respectively. On the other hand, εᵣ and V_{b} values for Al₂O₃ are 9-10 and 5 MV/cm respectively. The present embodiments may thus allow a large ratio (100-200 times) between the initial and final capacitances as the upper electrode reciprocates. More importantly, the initial capacitance may achieve up to 1000-2000 μF using an appropriate choice of dimensions.

We now consider the permittivity of grown thin dielectric layer and initial capacitance as 100 and 1000 μF respectively. For each cycle of operation, the following energy can be obtained:

$$Δ E = {E}_{1} ( k - 1 ) = \frac{1}{2} {C}_{1} {U}_{1}^{2} \cdot ( k - 1 ) ≃ \frac{( 1000 \cdot {10}^{- 6} F ) \cdot {( 10 V )}^{2}}{2} 100 = 5 J$$

The materials may be chosen so that the oxidized surfaces are porous.

The oxidized surface of the stationary plate may be immersed in an electrolyte solution, and typically the entire structure of the stationary plate and membrane is immersed in the electrolyte.

The membrane 40 may be porous to the electrolyte used, may be soaked in the electrolyte and may be placed between the internal faces.

The electrolyte may be any suitable salt solution having the necessary electrolytic properties. NaCl is generally the most conveniently available.

During one cycle of movement, generated energy from the generator of the present embodiments is shown as a function of initial voltages and different initial capacitances in FIG. 4.

It is clear that such electrostatic generator can provide sufficient energy (0.05 to 5 J) at an initial voltage of 10V. If the device is operated in the low-frequency range (10-100 Hz) then electrostatic generator can easily supply electrical power of 2-25 W, which may allow it to be used in many portable applications.

### Schematic Diagram for Geometrical Arrangements

Three more detailed implementations of architectures for the electrostatic generator of FIG. 3 using the same electrochemical principle are shown schematically in FIGS. 5 to 7.

Each of FIGS. 5 to 7 include the features of two electrodes 30, 32, with inner faces 34, 36 oxidized, a porous membrane 40, and an electrolyte solution 33. A spring 50 is explicitly present in FIG. 5, and in some cases, flexible plates may be used. Various means to apply mechanical forces may be provided.

As discussed, each electrostatic generator comprises two parts: a fixed part and a movable part. The lower electrode 32 is fixed and immersed in electrolyte solution 33 while the other electrode 30 is attached for movement. In FIG. 5, a spring 50 provides a restoring force against a flexible surface such as elastic metallic membrane 51, which flexes under an external force. FIG. 6 uses elastic membrane 52 to allow mobile electrode 30 to respond to an alternating mechanical force, and in FIG. 7 the upper electrode 30 forms a piston that reciprocates under the alternating mechanical force.

A flexible plate may transfer an external mechanical motion to the upper electrode to push the upper electrode down to the porous membrane 40 and then the means of providing a restoring force moves the upper electrode away from the porous membrane, hence allowing the generator to take advantage of the energy provided by the movement. More particularly, the porous membrane is placed on top of the lower electrode and soaks up electrolyte solution. In the case of FIG. 5, Spring 50 is connected with the flexible plate in order to control the movement of upper electrode 30. The spring pushes the upper electrode 30 in the upward direction, thus separating the upper electrode from the membrane and introducing an air gap. At the start of each cycle, both electrodes 30, 32, forming the variable capacitor, are connected to a voltage source and an external mechanical force is applied on the upper electrode to push it downward.

The capacitance increases with the movement of the upper electrode and reaches a maximum value when the upper electrode touches the electrolyte-soaked membrane. At this stage, the capacitor is disconnected in order to maintain constant charge across the capacitor plates. At this point, the mechanical force is removed and the upper electrode moves upwardly under influence of the spring, and, as a result, the mechanical energy is converted into stored electrostatic energy, causing a significant increase in the energy stored in the capacitor. The increased energy may be discharged to the device and the process is repeated multiple times in order to get consistent electric power generation.

FIGS. 6 and 7 operate on the same principle as FIG. 5, utilizing mechanical motion and a restoring force. The only difference is the way in which the restoring force is provided.

### Equivalent Electrical Circuit

Reference is now made to FIG. 8, which is a theoretical circuit diagram that demonstrates the operational principle of the electrostatic generator. The electrical elements include: C—Variable Capacitor; V₁—Voltage source; D₁, D₂ diodes for connecting-disconnecting the capacitor's plates to the voltage source and to a load V₂ that is represented in this example by a storage device; DC/DC converter.

At the start of a cycle, the variable capacitor is charged with energy from the first rechargeable voltage source (V₁) through the first diode (D₁) and the capacitor is disconnected from the battery in order to maintain constant charge on the capacitor plates. After that, the restoring force, for example an external force or the restoring force provided by the spring etc. moves the upper electrode 30 away from the soaked membrane 40 placed on the bottom electrode 32.

The capacitance decreases with the movement of the upper electrode and voltage across the capacitor rises. The scale of the rise is predefined as long as the movement is predefined. At this point, a second diode D₂ transfers charge from the capacitor to a load, which may be another battery, high capacity capacitors, or any power efficient device or to a rechargeable battery. Application and importance of D₂ is also discussed in U.S. Pat. No. 6,936,994, the contents of which are hereby incorporated herein by reference in their entirety. Continuous power generation is an essential requirement for portable devices. Efficient power is feasible if some part of the generated power is used to energize the capacitor. In order to get such power generation, the capacitor may be periodically connected and disconnected to and from a voltage source each time before applying a mechanical force.

The present embodiments may thus increase efficiency to provide a small scale power generator which is practical for mobile devices. The electrolyte-soaked membrane may as discussed play two important roles in this increase in efficiency. One role is to rule out or decrease the effect of air gap and other role is to prevent direct mechanical contact between both layers, the latter able to increase the service life of a generator made to the present embodiments.

Another use of a generator made to the present embodiments is as a high voltage source for radiation devices such as a gyrotron. As capacitance changes significantly, voltage across the capacitor increases sharply (V≈1/C), providing a suitable input for the gyrotron.

It is expected that during the life of a patent maturing from this application many relevant mechanical transmission mechanisms and restoring mechanisms, as well as suitable materials for membranes and electrolytes will be developed and the scopes of these and other terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the text is to be construed as if such a single embodiment is explicitly written out in detail. Conversely, various features of the invention, which are, for brevity, described in the context of a single embodiment, may also be provided separately or in any suitable subcombination or as suitable in any other described embodiment of the invention, and the text is to be construed as if such separate embodiments or subcombinations are explicitly set forth herein in detail.

Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. Generator comprising a parallel plate capacitor, the parallel plate capacitor comprising:
a mobile plate; and
a stationary plate, the mobile and stationary plates each having external and internal faces, the mobile and stationary plates facing each other in parallel at said internal faces, the mobile plate being movable by an external mechanical force to increase and decrease a gap with said stationary plate, thereby to change the capacitance between the mobile plate and the stationary plate, the internal faces comprising dielectric surfaces respectively.

2. The generator of claim 1, wherein said dielectric surfaces are oxidized and porous surfaces.

3. The generator of claim 1, wherein the dielectric surface of said stationary plate is immersed in an electrolyte solution.

4. The generator of claim 1, further comprising a porous membrane between said internal faces.

5. The generator of claim 4, wherein said porous membrane is soaked in said electrolyte.

6. The generator of claim 4, wherein the electrolyte is an acid or a salt solution.

7. The generator of claim 1, wherein the plates comprise a conductive material.

8. The generator of claim 1, wherein the plates comprise aluminum and the oxidized surfaces comprise aluminum oxide or wherein the plates comprise tantalum and the oxidized surfaces comprise tantalum oxide.

9. The generator of claim 1, wherein the mobile plate is connected to a flexible surface to move in response to said external mechanical force.

10. The generator of claim 9, wherein said mobile plate is further connected to a spring to provide a restoring force against said external mechanical force.

11. The generator of claim 9, configured to cause said mobile plate to reciprocate in response to said external mechanical force.

12. The generator of claim 11, wherein said mobile plate is configured as a piston.

13. The generator of claim 1, wherein said mobile plate is configured to move between a low capacitance position in which there is no airgap between the plates, and a high capacitance position in which there is an airgap between the plates.

14. The generator of claim 13, wherein said parallel plate capacitor is connected via a diode to a voltage source to allow for charging when in said low capacitance position but to prevent discharge to said voltage source from said high capacitance position.

15. The generator of claim 13, wherein said parallel plate capacitor is connected via a diode to a load to allow for discharging to said load when in said high capacitance position but to prevent discharge to said load until said high capacitance position is reached.

16. A parallel plate capacitor comprising:
a mobile plate; and
a stationary plate, the mobile and stationary plates each having external and internal faces, the mobile and stationary plates facing each other in parallel at said internal faces, the mobile plate being movable by an external mechanical force to increase and decrease a gap with said stationary plate, thereby to change the capacitance between the mobile plate and the stationary plate, the internal faces comprising dielectric surfaces respectively.

17. The parallel plate capacitor of claim 16, wherein said dielectric surfaces are oxidized and porous surfaces.

18. The parallel plate capacitor of claim 16, wherein the dielectric surface of said stationary plate is immersed in an electrolyte solution.

19. The parallel plate capacitor of claim 16, further comprising a porous membrane between said internal faces.

20. The parallel plate capacitor of claim 19, wherein said porous membrane is soaked in said electrolyte.

21. The parallel plate capacitor of claim 16, wherein said mobile plate is configured as a piston and is further connected to a spring to provide a restoring force against said external mechanical force, thereby to cause said mobile plate to reciprocate in response to said external mechanical force.
